(19) United States
(12) Patent Application Publication
(10) Pub. No.: US 2011/0113662 A1
(43) Pub. Date: May 19, 2011

(54) BARRIER

(75) Inventors: Spencer Saunders, Surrey (GB); Gordon Evans, Surrey (GB)

(73) Assignee: T4 MEDIA LIMITED, London (GB)

(21) Appl. No.: 13/000,804

(22) PCT Filed: Jun. 23, 2009
(86) PCT No.: PCT/GB09/50718

§ 371 Date: Dec. 22, 2010

(30) Foreign Application Priority Data
Jun. 23, 2008 (GB) 0811510.7

(51) Int. Cl. G09F 13/04; G09F 7/10; G09F 19/04; G09F 19/22

(52) U.S. Cl. 40/582; 40/606.07; 40/541

(57) ABSTRACT

A barrier for use in a barrier system is described. The barrier is movable to control access past the barrier, and said barrier comprises a media support means arranged to support a removable media to be displayed. The support means defines a media receiving path along which the media is movable to an inserted position in which the media is displayed.

### FIELD OF THE INVENTION

The present invention relates to an improved barrier. Moreover, the present invention relates to a barrier for displaying a media, such as advertising media.

### BACKGROUND OF THE INVENTION

Moving barriers, for example, barriers with moving arms are useful for controlling the access of vehicles and people past the barrier—for example into a car park, or onto a train platform. Before being allowed past the barrier, it is generally necessary for a user to pause in front of the barrier so that access can be authenticated—for example by feeding a ticket into a ticket machine and waiting for the barrier to move. The user therefore needs to be looking at the barrier in order to know whether and when passage is allowed via the barrier. This presents an advertising opportunity, in that advertising media can be mounted on the barrier to be observed by the user.

Generally, owners of advertising space charge advertisers for a particular time period during which advertisements occupy the advertising space. When the time period is over, it is necessary to remove the existing adverting media and replace it with another. In order to effect the changeover, it is required that a trained worker travels to the location that the advertising space is located, removes the existing media, and replaces it with the new advertising media. This has a cost associated with it which typically needs to be paid by the advertiser, and is paid for as production charge for the advertising campaign. As such, advertising campaigns of a short duration can be uneconomical where the overhead associated with changeover costs (e.g. material and labour costs) are not covered by the revenue generated. Therefore, advertising space owners generally impose a minimum on the cost and duration of the advertising campaign. This limits the number of advertisers to those who are prepared to accept the minimum duration and cost.

Presently, it is known to provide advertising on barriers, but such advertising material tends to be at least semi-permanent as it is integral with the barrier. Therefore, changing the media requires specialist tools and a great deal of time and materials. For example, the trained work would typically need to remove the existing barrier (which is integral with the media) and fit a new barrier with the new advertising media.

The reason why advertising media tends to be permanent/integral with such barriers is because it is preferable to use a minimal amount of material for the barrier, if the barrier is to be movable. This is because the barrier weight is a very important consideration in the design of a movable barrier. If the barrier is heavy then a greater force is required to move it. If the barrier has a movable arm which is moved by an electric motor, then a heavier barrier arm will therefore require a larger, more powerful motor to move it. This can unnecessarily increase the cost and size of the barrier. If additional weight were to be added to an existing barrier system, for example, by adding a heavier barrier arm than normal, the life of the barrier system—in terms of number of raising and lowering cycles—would be reduced. This can increase maintenance costs.

Thus there is a general prejudice against having advertising media on barrier arms at all because doing so tends not to be as cost effective as other forms of advertising, unless the advertising campaign is long term. There is also the issue that advertisers do not generally like to spend large proportions of their budgets on productions costs as they feel this constricts media planning. Current production costs are approximately 18% of total media costs.

Another problem is that barriers can be located within poorly lit areas—for example, underground car parks, and so the displayed media on the barrier may not be easily visible. In such situations, the effectiveness of the advertisement can be severely reduced.

Therefore, an improved barrier is required to permit advertising space on the barrier arm to be more effectively utilised. In particular, it is desirable to reduce the production costs to around 5% of total media costs.

The present invention attempts to overcome the above-mentioned problems, at least in part.

### SUMMARY OF THE PRESENT INVENTION

According to a first aspect of the present invention, there is provided a barrier for use in a barrier system in which the barrier is movable to control access past the barrier, the barrier comprising a media support means arranged to support a removable media to be displayed, the support means defining a media receiving path along which the media is movable to an inserted position in which the media is displayed.

This arrangement permits the advertising media to be quickly manually inserted and removed into the media support means without the use of special tools, or under the direction of a skilled worker. For example, a car park attendant could be provided with a simple set of instructions and the replacement media, and attend to the media changeover without any further help. This allows for a quick and easy changeover. In this way, shorter advertising campaigns become economically viable, thereby maximising the number of advertisers prepared to advertise on the advertising space provided by the barrier arm.

Furthermore, the media changeover process involves a simple manual operation, without the need to manoeuvre any moving parts. The lack of need for moving parts makes the barrier resistant to mechanical failure. Furthermore, there are no parts to go missing (e.g. screws), and no tools are necessary to implement the changeover. The support means allows for the interchange to take place merely by moving the media along the media receiving path.

It will be understood that the term media used herein is intended to include a singular advertising medium as well as plural advertising media.

Preferably, the barrier comprises a barrier arm. The barrier arm may be elongate. Preferably, the barrier arm comprises the media support means.

The barrier and/or barrier arm may be arranged to be moveable to control access along an access path by changing its position and/or orientation relative to the access path. The barrier and/or barrier arm may be arranged to be moveable by pivoting about a pivot point. Preferably, the pivot point is adjacent to an end of the barrier and/or barrier arm.

Preferably, the support means is arranged to permit the media to be slidably moveable along the media receiving path. Preferably, the support means is arranged to permit the media to be moveable along the media receiving path in a direction substantially parallel to a longitudinal axis of the barrier arm.

Preferably, the media support means comprises a frame which defines an opening through which an inserted media is substantially visible. Preferably, the opening is arranged to facilitate manual manipulation of media during media insertion and/or removal.

The opening allows the media to be displayed to be directly visible, which can maximise the aesthetic appeal and visibility of the media. This also removes the need, for example, for a transparent viewing plate. Although such a transparent viewing plate could potentially protect the media from damage and/or unauthorised removal, there are many disadvantages associated with the use of such a transparent viewing plate on a barrier; it increases the material cost of the barrier, dirt can build up between the plate and the media to be advertised and the reflectance of the viewing plate would detract from the aesthetic appeal of the media—especially if the viewing plate becomes scratched. Relatively lightweight transparent plastics material is particular susceptible to scratches. Another importantly issue is that a transparent viewing plate would add substantially to the weight of the barrier, particularly if made from glass (which is less susceptible to scratching).

The opening can therefore allow the media to be easily cleaned without any specialist knowledge or equipment—for example a car park attendant can be employed to wipe the surface of a displayed media in the event of a build up of dirt.

Another advantage associated with the opening is the fact that the media can be manually manipulated through the opening and so removes the need for tools or moving parts during the installation and removal of media from the barrier.

Preferably, the media receiving path is non-linear, at least in part.

This has the advantage of frictionally engaging a flexible media in the path, acting to retain an inserted media within the media support means, preventing unwanted removal.

The support means may comprise a slot allowing media to be inserted and/or removed into the media receiving path from an exterior of the support means. Preferably, the media receiving path is non-linear at a position proximal to the slot. The media receiving path may be non-linear only at a position proximal to the slot.

This has the advantage of the frictional engagement being localised in an area close to the media entry and/or exit point, and so acts to prevent unwanted removal of the media.

The slot may be sized to receive an introduced edge of a media to be inserted. Preferably, the slot is substantially sized to be slightly bigger than the cross section of the media to be inserted.

Advantageously, this allows the media to be inserted easily, but minimises the chance of the media being unintentionally removed from the support means.

Preferably the slot is shaped to incorporate a recess for facilitating manual manipulation of an inserted media to be removed. Preferably, the recess is of a different proportion to that of the cross section of a media to be inserted. Preferably, the recess is sized to permit a finger of a user to grasp an inserted media for facilitating removal of said inserted media.

Advantageously, the recess of different proportions allows, for example, a user to remove the media easily, whilst at the same time, acting to retain the media against unintentional removal.

The support means may comprise a media receiving cavity which is, at least in part, occupied by an inserted media after the inserted media has been moved into the inserted position by movement along the media receiving path. The media receiving cavity may comprise at least part of the media receiving path. Preferably, the media receiving cavity comprises a media capture portion for capturing a trailing edge of an inserted media. Preferably, the captured trailing edge of the media is that which is proximal to the slot.

Advantageously, the media capture portion serves to capture a trailing edge (i.e. last in, first out) of an inserted media, and this media capture portion is next to the entry/exit point provided by the slot so that an inserted media is prevented from unintentional removal from the support means.

Preferably, the barrier comprises a lighting arrangement arranged to illuminate a media to be displayed.

It will be understood that the addition of a lighting arrangement on a barrier will add weight, and so a larger force is required to move the barrier arm—and so in the case that the barrier or barrier arm is powered by an electric motor, a more powerful, and therefore more costly motor is required. Even if a pivoting barrier/barrier arm is balanced with a counter-weight, problems associated with inertia would still require a more powerful motor in order to move the barrier/barrier arm at a satisfactory speed. However, advantageously, the provision of such a lighting arrangement can improve the visibility and the aesthetic appeal of advertising media on the barrier. Furthermore, the provision of advertising on the barrier can generate revenue that can be used to offset the increased cost of a more powerful motor.

Preferably, the lighting arrangement is a backlit lighting arrangement. Advantageously, this improves the aesthetic appeal and visibility of the advertising media—more so than a front illuminated display which suffers from light reflectance problems.

Preferably, the lighting arrangement uniformly illuminates substantially the entire visible surface of an inserted media. Preferably the lighting arrangement comprises diffusing means arranged to provide uniform illumination. The diffusing means may comprise a diffusing material or coating. Preferably, the material or coating is white.

The lighting arrangement may comprise a light source. The light source may be a solid-state light source. Preferably, the light source comprises a light-emitting diode. Preferably, the light emitting diode is a white light emitting diode.

At first consideration, light emitting diodes (LEDs) provide relatively directional light, and so appear to be unsuitable for the task of providing uniform backlit illumination of media. Furthermore, the spectral quality and consistency of light from LEDs is generally low, and so for display purposes (for example, in other backlit applications) fluorescent tubes are favoured. However, advantageously, light-emitting diodes have a high light output to weight ratio—this is particularly important when seeking to avail unnecessary barrier weight increases. Furthermore, LEDs are very resilient to breakage—which is significant for a barrier that is subject to a high level of movement, and sudden stoppage (for example onto a barrier arm buffer).

Further advantages of using LEDs include good energy efficiency, good longevity (thereby minimising maintenance of the barrier) and not containing a significant level of harmful materials (in particular, disposal of mercury within fluorescent tubing is a significant problem).

Preferably, the light source is positioned relative to the media receiving path such that when a media is in the inserted position, light from the light source is emitted directly towards the media to maximise lighting of the media. Preferably, light source is directed substantially perpendicular to a plane of an inserted media.

The light source may be spaced from the media receiving path. Preferably, the light source is spaced from the media receiving path at a distance chosen to allow light from the light source to diffuse to an extent that when the media is in the inserted position, the media is illuminated substantially uniformly.

Preferably there are a plurality of light sources. Preferably, the plurality of light sources are positioned relative to one another to direct a uniform amount of light towards the media receiving path. Preferably, the plurality of light sources are regularly distributed within the lighting arrangement. Preferably, the plurality of light sources are evenly interspaced relative to one another. The plurality of light sources may be in a row or matrix arrangement.

Advantageously, by controlling the position of the light sources relative to one another and the media, the media can be illuminated uniformly.

Preferably, the lighting arrangement comprises a reflector arranged to redirect any light falling on the reflector to illuminate an inserted media to be displayed. The reflector may be concave. The reflector may comprise the diffusing means. Advantageously, the reflector can maximise the illumination efficiency of the lighting arrangement. A further advantage is that when directional light sources are used, the reflector can be arranged to diffuse the light from the light sources in a manner promoting uniform light distribution.

Preferably, the barrier and/or barrier arms comprises a rear shell portion for housing the lighting arrangement and the media to be displayed. Preferably, the rear shell portion is concave so as to accommodate the shape of a concave reflector. The barrier and/or barrier arm may be integral with the reflector.

The rear shell portion may comprise a luminescent strip arranged to increase the visibility of the rear of the barrier, especially in low light.

Advantageously, the concave shape of the barrier/barrier arm improves the strength to weight ratio of the barrier arm, and serves to improve the aesthetic appeal of the barrier.

The barrier and/or barrier arm may comprise a cross-plate. The cross-plate may be upstanding from the reflector, the barrier and/or the barrier arm. Advantageously, the cross-plate can provide structural reinforcement to the reflector, the barrier and/or barrier arm.

The cross-plate may be transparent or translucent. Advantageously, this allows light to be transmitted through the cross-plate to maximise illumination, whilst at the same time providing structural support.

The cross-plate may be arranged to support one or more light sources. The cross plate may be arranged to support one or more light sources spaced from the reflector. A plurality of cross plates may be provided and may be evenly interspaced along the length of the reflector. The arrangement of the cross plates can promote substantially uniform distributed illumination of the media in use.

Preferably, the barrier is arranged to receive a control signal from a sensor for detecting the presence or absence of a predetermined object within the vicinity of the barrier and control the lighting arrangement in response to the control signal. Preferably, the lighting arrangement is controlled in response to the control signal so as to illuminate the display when the predetermined objected is detected to be within the vicinity of the barrier. Preferably, the lighting arrangement is controlled in response to the control signal so as to de-illuminate the display after a predetermined time period when no object is detected to be within the vicinity of the barrier. The barrier may comprise the sensor. The sensor may be a motion sensor such as a proximity sensor.

Advantageously, the sensor-control arrangement can save on energy by only activating the lighting arrangement when there is a user within the vicinity of the barrier to see the displayed media. Furthermore, the activation of the lighting arrangement in the presence of a user or vehicle that has recently arrived within the vicinity of the barrier is more eye-catching than an always-on lighting arrangement. Furthermore, the activation of the lighting arrangement provides useful feedback to a user about the positioning of the predetermined object (e.g. the user, the user's car) with respect to the barrier—which can improve the working relationship between the user and the barrier (for example, by prompting the user to manoeuvre into the correct position with respect to the barrier). The lighting arrangement may be arranged to blink or flash.

Further aspects of the present invention will now be described. It will be understood that further aspects of the present invention may incorporate features relating to the first aspect of the present invention, and visa-versa, where context allows.

According to a second aspect of the present invention there is provided a barrier for use in a barrier system in which the barrier is movable to control access past the barrier, the barrier comprising media support means arranged to support a media to be displayed, and a lighting arrangement arranged to illuminate the media.

The lighting arrangement permits the advantage of more effective advertising to be realised.

According to a third aspect of the present invention there is provided a barrier kit comprising a barrier according to the first or second aspect of the present invention, the barrier kit further comprising a media suitable for advertising for support by the media support means of the barrier.

Preferably, the media is made from a flexible material. Preferably, the media is made from an elongate material. Advantageously, the flexibility and elongate nature of the media facilitates its insertion into, and removal from the barrier arm.

Preferably, the media is translucent and/or transparent, at least in part. Advantageously, the translucent material permits light transmission via the media improving the visual effect of the media, and is particularly suited to the backlit arrangement described herein.

Preferably, the media comprises a wipe-clean surface. Preferably, the media comprises a weatherproof material. For example, the media could be laminated, for example with a plastic laminate. Advantageously, in the case that the media is exposed to the elements (thereby maximising the visual impact of the media) the weatherproofing promotes the integrity of the material, and the media can be easily cleaned.

The barrier kit may comprise a plurality of interchangeable media.

According to a fourth aspect of the present invention there is provided a barrier for use in a barrier system in which the barrier is movable to control access past the barrier, the barrier comprising a lighting arrangement arranged to display an illuminated image suitable for advertising.

Preferably, the lighting arrangement comprises an electronic display means. Preferably, the electronic display means comprises a plurality of LEDs, preferably in a matrix arrangement.

An electronic display means has the advantage of being capable of being controlled remotely and being updatable instantaneously. Therefore, no manual changeover of the media is required minimising advertising changeover costs. Further, better control is provided over the duration and nature of the advertising images—which can even be animated.

For example, media space can be sold for temporal display, namely in time periods called “spots” which are displayed for shorter time periods than a usual two week campaign and content can be refreshed daily—for example, changing flight prices etc.

According to a fifth aspect of the present invention there is provided a barrier system, comprising a barrier or a barrier kit according to the first, second, third and/or fourth aspects of the present invention, the barrier system being operable to move the barrier to control access past the barrier.

Preferably, the barrier system comprises a drive means operable to drive the movable arm in response to an access signal. Preferably, the barrier system comprises an access control means for controlling user or vehicle access past the barrier along an access path. Preferably, the access control means is arranged to transmit an access signal to the drive means in response to an access verification process. The access verification process may comprise withdrawing or validating a ticket.

The barrier system may comprise an electrical power source. Preferably, the power source is located outside the barrier. Advantageously, this reduces the weight of the barrier thereby minimising the power needed to move the barrier. Preferably, the barrier system comprises a wiring configuration arranged to electrically couple the barrier to the power source, said wiring configuration being arranged to maintain the electrical coupling during movement of the barrier. Preferably, the power source is adapted to power the drive means and the lighting arrangement. Advantageously, this means separate power supplies are not required for each of the drive means and the lighting arrangement.

### BRIEF DESCRIPTION OF THE DRAWINGS

Embodiments of the present invention will now be described, by way of example only, with reference to the accompanying drawings in which;

FIG. 1 shows a front view of a barrier system according to a first embodiment of the present invention;

FIG. 2 shows a schematic front view of a barrier of the barrier system of FIG. 1;

FIG. 3 shows a schematic cross sectional view of the barrier of FIG. 2 taken from section line III-III;

FIG. 4 shows a schematic cross sectional view of the barrier of FIG. 2 taken from section line IV-IV;

FIG. 5 shows the schematic cross sectional view of FIG. 4, with a media to be displayed partially inserted into a media support means of the barrier;

FIG. 6 shows the schematic cross sectional view of FIG. 5, with the media to be displayed almost completely inserted into the media support means;

FIG. 7 shows the schematic cross sectional view of FIG. 6, with the media to be displayed completely inserted into an inserted position within the media support means;

FIG. 8 shows a perspective view of the barrier with the media partially inserted into the media support means, as shown schematically in FIG. 5;

FIG. 9 shows a perspective view of the barrier of the barrier system of FIG. 1 together with a preferred lighting arrangement;

FIG. 10 shows a perspective view of the barrier of the barrier system of FIG. 1 together with an alternative lighting arrangement; and

FIG. 11 shows a schematic front view of a barrier according to a second embodiment of the present invention.

### DETAILED DESCRIPTION OF PRESENTLY PREFERRED EMBODIMENTS

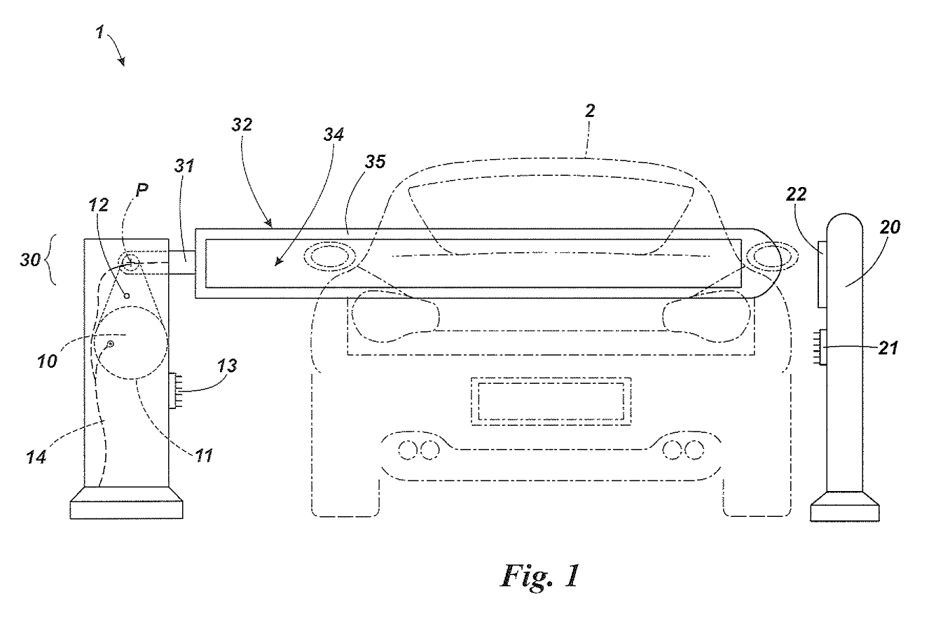

FIG. 1 shows a barrier system 1 suitable for use in a car park access system. The barrier system 1 comprises a drive unit 10, an access control means 20 and a barrier 30. The rear of a stationary vehicle 2 in front of the barrier 30 is shown in a broken outline.

The access control means 20 comprises a motion sensor 21 and a ticket dispenser 22. The motion sensor 21 is arranged to detect the presence of the vehicle 2 and, on detection, transmit a control signal. The ticket dispenser 22 is arranged to receive the control signal from the motion sensor 21.

The drive unit 10 comprises a drive means in the form of a motor 11. The motor 11 is connected via gearing 12 to the barrier 30. The motor 11 and gearing 12 are operable to raise and lower the barrier 30 by rotating it about a pivot point P so as to permit or deny access to vehicles. Although not shown in FIG. 1, the barrier 30 may be counterweighted about its pivot point P to reduce the stress on the motor 11.

The drive unit also comprises a safety sensor 13 which ensures a passing vehicle is clear of the barrier 30 before a raised barrier 30 is lowered.

Briefly, in operation, the vehicle 2 pulls up alongside the access control means 20 to enable a user of the vehicle 2 to operate the access control means 20. The ticket dispenser 22, on receiving the control signal, dispenses one of a number of tickets to be drawn from the ticket dispenser 22. On removal of a ticket dispensed from the ticket dispenser 22, the access control mean 20 transmits an access control signal to the drive unit 10 which, in response, operates the motor 11 and gearing 12 to move the barrier 30, to permit the vehicle 2 access along an access path past the barrier system 1. The safety sensor 13 detects that the vehicle has successfully passed the barrier system 1, and then permits lowering the barrier 30.

Further details of the barrier system 1, in particular, the barrier 30 will now be described.

The barrier 30 comprises a barrier arm 31 and media support means 32. The barrier arm 31 supports the media support means 32. The media support means 32 is arranged to support advertising media 34 to be displayed. The media support means 32 comprises a frame 35 which defines a central opening 36 through which the media 34 is directly visible in use. A user of the vehicle 2 stationary in front of the barrier 30 therefore will be directly in front of the advertising media 34, and so would be looking at the advertising media 34, especially when pulling up to the barrier system 1, and when waiting for the barrier 30 to rise.

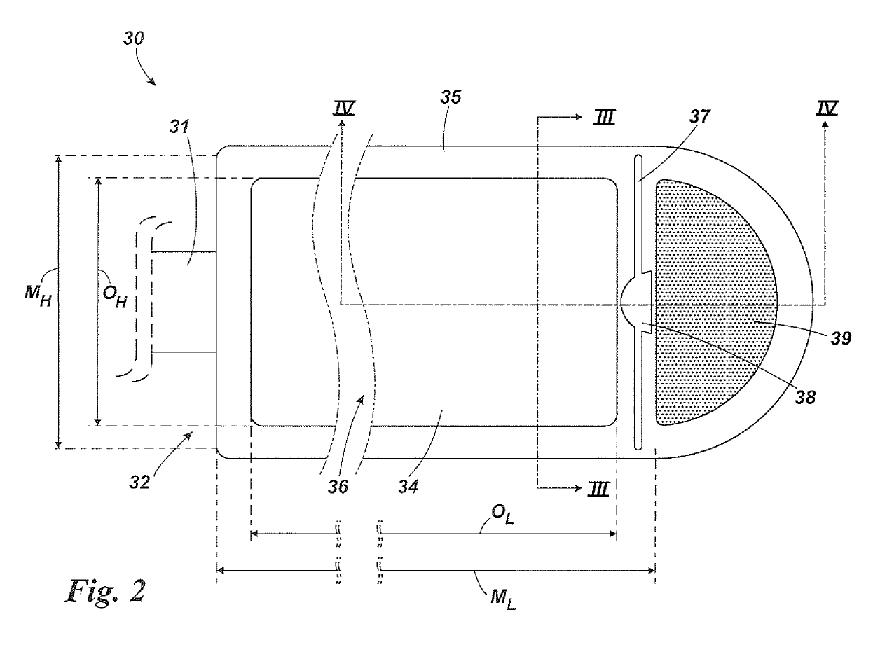

FIG. 2 show a schematic front view of part of the barrier 30, in particular the regions proximal and distal from the drive unit 10. The frame 35 is constructed from an integral piece of plastic shaped to define the opening 36, and also shaped to define a slot 37 through which the media 34 can be inserted and removed into the media support means 32. The size of the slot 37 is of the same shape, but slightly larger than the cross sectional area of the media 34 to be inserted. The slot 37 comprises a recess 38 shaped to facilitate insertion and removal of the media 34 in that the recess 38 facilitates manual manipulation of an inserted media 34 by a user as will be described. The frame 35 is also shaped to define a semi-circular shaped depression 39 into which a logo (for example, belonging to a manufacturer or distributor) could be mounted.

The media 34 has an area greater than the area of the opening 36 such that a periphery of an inserted media 34 is trapped behind the frame 35. Specifically, a media height M_{H} and a media length M_{L} are each longer than a respective height O_{H} and length O_{L} of the opening 36.

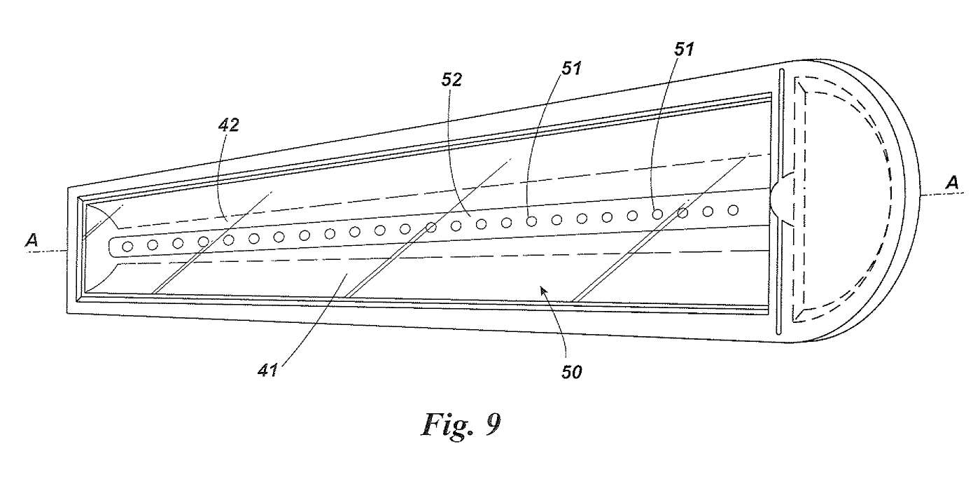

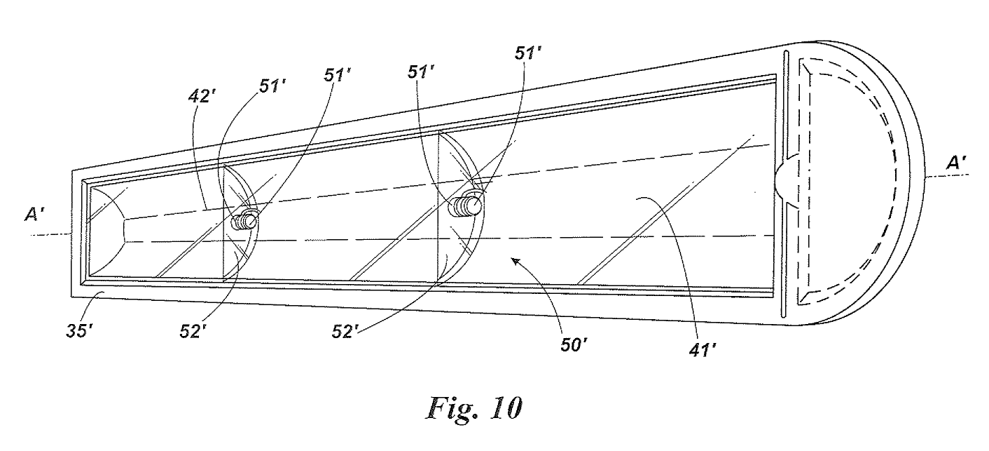

FIG. 9 shows a perspective view of the media support means 32 which is shown without a media 34 inserted therein. The media support means 32 comprises a lighting arrangement 50 which comprises a translucent lens portion 34, a reflector 42 and a plurality of LED light sources 51. An alternative lighting arrangement 50′ is shown in FIG. 10. The lighting arrangements 50, 50′ will be described in more detail below.

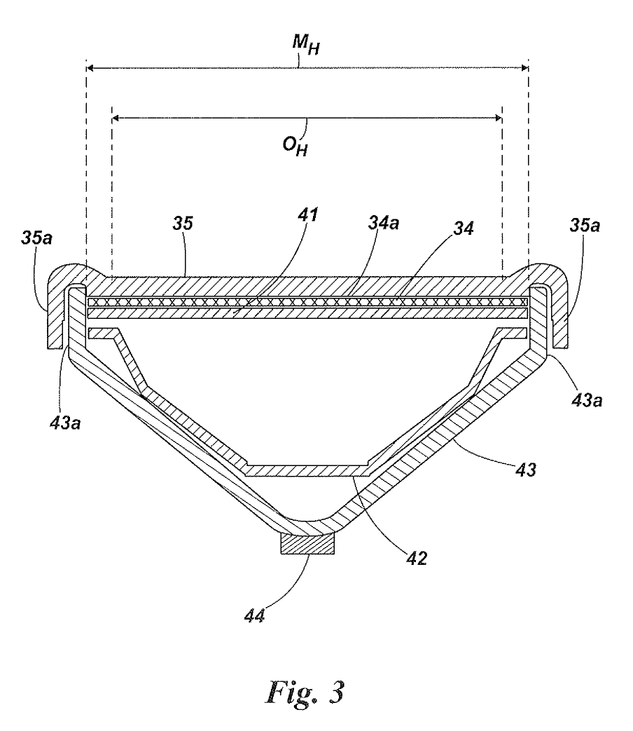

Referring to FIG. 3, a schematic cross sectional view of the media support means 32 taken from section line III-III of FIG. 2 is shown. The media support means 32 comprises a rear shell portion 43 and a luminescent strip 44. The luminescent strip runs along substantially the length of the rear shell portion 43 and acts to make the rear shell portion 43 at the un-illuminated rear of the barrier 30 visible in low lighting conditions.

The rear shell portion 43 is concave in shape and sized to accommodate the reflector 42 which is of a smaller concave shape. The rear shell portion also accommodates the lens portion 41 and the media 34 to be displayed. The rear shell portion 43 comprises a projecting rim 43a which engages with a complementary shaped sidewall 35a of the frame 35 in a push-fit arrangement. This permits easy assembly of the media support means 32. During assembly, the frame 35 is fixed to the rear shell portion 43 using epoxy glue, or other suitable fixing means. This promotes the rigidity of the assembled structure.

The frame 35 and the lens portion 41 are substantially planar and parallel and spaced from one another. Therefore, the frame 35 and the lens portion 41 together with the projecting rim 43a of the shell portion 43, define a media receiving cavity 34a in which the media 34 may be accommodated. Specifically, the media receiving cavity 34a is defined by an inside surface of the frame 35 bordering the opening 36 which faces towards the lens portion 41, the surface of the lens portion 41 which faces toward the frame 35, and the rim 43a of the shell portion 43. The cross-sectional thickness of the media 34 is sized to be slightly smaller than the spacing between the lens portion 41 and the frame 35. Thus, there is a small amount of frictional engagement between the media 34 and the lens portion 41 and/or the frame 35 such that the media 34 is held in place during normal operation of the barrier 30 (for example, when the barrier 30 rises and falls to permit access). However, the media 34 is also free to slide along itself, along the length of the media receiving cavity 34a during manual insertion and removal as will be described below.

Referring back to FIG. 9, a preferred lighting arrangement 50 is shown. A light source support means in the form of an LED tube 52 supports a plurality of white light LED light sources 51. The LED light sources 51 are evenly interspaced from one another in a row within the LED tube 52 along the longitudinal axis A of the barrier 30. The LED tube 52 is positioned towards the rear of the reflector 42 spaced away from the lens portion 41 and the media 34 to be illuminated such that light from the LED light sources 51 can diffuse sufficiently so that a relatively even illumination of the media 34 is achieved. The light sources 51 face towards the lens portion 41 and the media 34 to be illuminated and are oriented substantially perpendicular to the plane of the lens portion 41 and the media 34 to be illuminated.

In this specific example, the LED light sources 51 each have a lighting angle of approximately 120 degrees, are spaced apart from one another at a distance of approximately 22 mm, and are spaced from the lens portion 41 at a distance of approximately 60 mm. The LED tube 52 is approximately 1.2 metres long and comprises twenty-five LED light sources 51 surface mounted on a PCB strip within the LED tube 52. However, it will be appreciated that other configurations are also possible to achieve the desired uniform illumination of the media 34.

Generally, a large number of light sources, a wide lighting angle per light source, a close interspacing between light sources and a large distance between the light sources to the media to be illuminated maximises the mixing of light from different light sources thereby providing relatively uniform illumination of the media 34. In this arrangement, light travelling from each light source to the media has sufficient space to diverge and mix to form a diffuse backlit lighting arrangement.

The lens portion 41 is made from clear polycarbonate which allows light transmission therethrough. Other materials, which are preferably clear/translucent, relatively lightweight and resilient—for example plastics materials such as acrylic—may also be used.

The reflector 42 has a diffuse white coating arranged to diffuse light emitted from the light sources 51. This together with the spatial arrangement and orientation of the light sources 51 facilitate light to be diffused in an even manner out through the lens portion 41 to the rear surface of an inserted media.

Thus the lighting arrangement 50 serves to backlight evenly a media 42 held within the media support means 32.

Although the lighting arrangement in FIG. 9 is preferred, alternative lighting arrangements are possible—as shown in FIG. 10. Here the lighting arrangement 50′ comprises light sources 51′ that are not disposed along the length of the reflector 42 and do not face towards the lens portion 41′ (as in FIG. 9) but rather have light output directed along the length of the reflector 42, along the longitudinal axis A′ of the barrier 30.

This alternative lighting arrangement 50′ comprises cross plates 52′ which are oriented substantially perpendicular to the lens portion 41′ and have a roughly semi-circular profile the shape of which conforms to the portion of the reflector 42′ and the lens portion 41′ with which the cross plates 52′ are fixed in contact (see FIG. 3). Contact of the cross plates 52′ and the lens portion 41′ and reflector 42′ promotes the structural integrity (strength) of the barrier 30′.

Light sources 51′ are mounted roughly at the centre of each face of each cross plate. Thus, light sources 51′ on opposing faces of the same cross plate 52′ direct emitted light away from one another. The faces of the cross plates 52′ are oriented in a direction substantially along the length of the barrier 30′, parallel to the longitudinal axis A of the barrier 30′, so that light emitted from the light sources 51′ are directed along the length of the reflector 42′.

It will be appreciated that in an alternative embodiment, structures such as the cross-plates 52′ may be used in the lighting arrangement 50 shown in FIG. 9, for example to add rigidity.

Referring back to FIG. 1, the barrier system 1, specifically the drive unit 10 and the access control means 20, are wired into an external electrical mains power source. Electrical power is supplied to the barrier 30 to power the lighting arrangement 50 via a wire 14 located close to the point at which the barrier 30 pivots relative to the drive unit 10 during movement of the barrier 30 (see FIG. 1).

In operation, the lighting arrangement 50 is arranged to receive the control signal transmitted from the motion sensor 21 and in response, activate the light sources 51 (i.e turn them on, or blink them). Thus, the media 34 becomes brightly lit when the vehicle 2 approaches the barrier 30, thereby grabbing the attention of a user in the car, maximising the visual impact of the advertisement on the media 34.

The motion sensor 21, which is shown in FIG. 1 to be located on the access control means 20, may be located within the barrier arm 32 in alternative arrangements. In particular, the motion sensor 21 may be located within the semi-circular shaped depression 39 to be facing on-coming vehicles.

Manual insertion and removal of the media 34 will now be described.

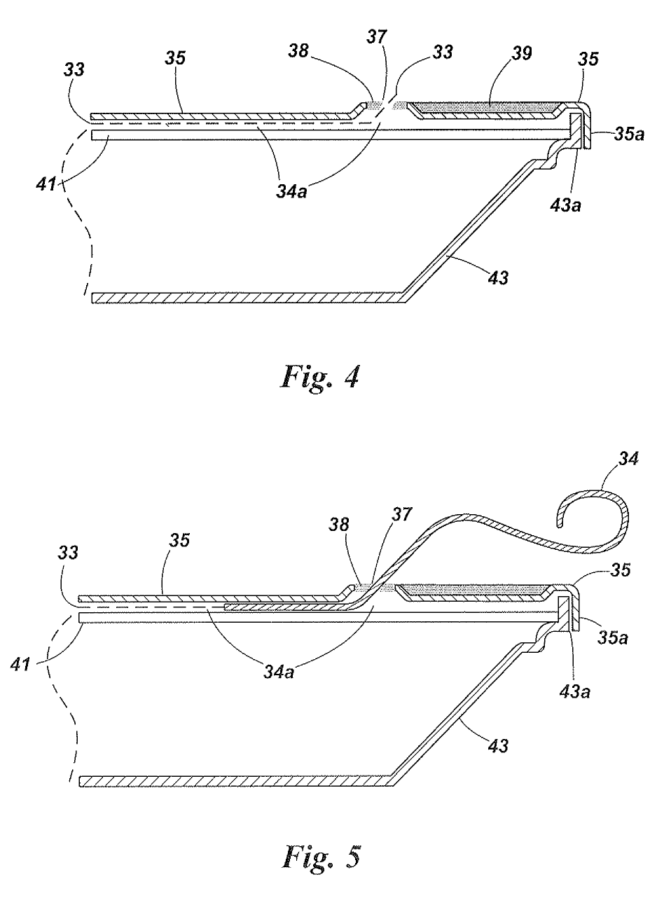

FIG. 4 shows a schematic cross-sectional view part of the media support means 32 as shown in FIG. 2, taken from section line IV-IV. For clarity, the reflector 43 and light sources 51 of the lighting arrangement 50 are not shown.

As mentioned previously, the frame 35 defines a slot 37 through which the media 34 can be inserted and removed from the media support means 32. The media 34 is not shown here in FIG. 4.

As can be better seen in FIG. 2, the slot 37 is elongate—defining an opening having a thickness and height sized to facilitate the media 34 to be fed through the slot. The length of the slot 37 is slightly longer than the height of the media M_{H}. For the avoidance of doubt the length of the slot is significantly longer than the height of the opening O_{H} of the frame 35.

Referring to FIG. 4, a media 34 fed through the slot 37 can be manipulated to move the media 34 along a media receiving path 33 (shown as a dashed line in FIGS. 4 to 7). The media receiving path 33 is non-linear in that the media 34 will have to bend as it is slid past the slot 37 and into the media receiving cavity 34a between the frame 35 and the lens portion 41.

The slot 37 is shaped to introduce the media 34 at an angle to the orientation of plane of the lens portion 41. Specifically, the slot 37 is shaped so that the media 34 is fed through the slot 37 and into the media receiving cavity 34a at an angle to the lens portion 41, but which is in a direction toward that which the media 34 is slidable to move it towards an inserted position. The angle is preferably approximately 45 degrees to the plane of the lens portion, but angles between 20 and 70 degrees are also suitable. This arrangement allows the media 34 to be inserted easily, whilst at the same time preventing unwanted removal of the media.

FIG. 5 shows a media 34 partially inserted into the media support means 32. As can be seen, the media 34, following the media receiving path 33 needs to bend at a region proximal to the slot in order to be slidable along the media receiving path 33.

Frictional engagement between the media 34 and surrounding structures (i.e. the lens portion 41 and the frame 35) can cause the media 34 to buckle, making entry of the media 34 to the inserted position within the media support means 32 difficult, or impossible by simply feeding the media 34 by pushing it into through the slot 37. The flexibility of the media 34 necessary for it to follow a curvilinear path into the media support means 32 increases the chance of buckling, especially as more of the media 34 is fed past the slot 37. However, the positioning of the opening 36 close to the entry point defined by the slot 37 obviates this problem.

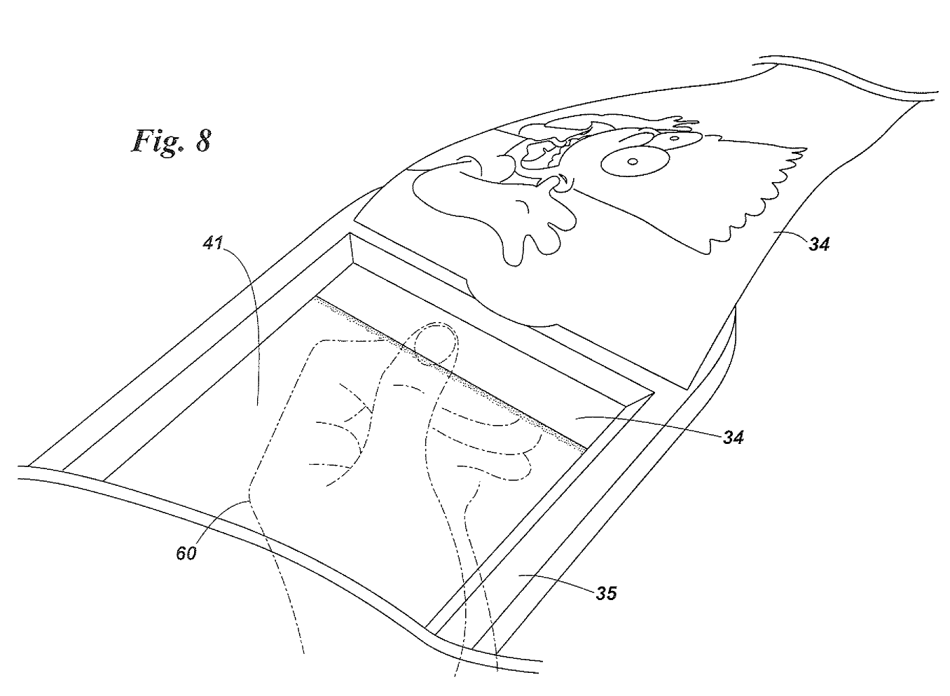

As can be seen in FIG. 8, in which there is shown a perspective view of the media 34 partially inserted (as schematically shown in FIG. 5), it is possible for a user to manually manipulate the introduced fed edge of the media 34 to draw the media 34 along the media receiving path 33 towards the inserted position for display. The user's hand 60 is shown in broken outline grasping the end of the media 34.

This arrangement is particularly advantageous in respect of elongate barriers—as are typical in car park barriers. This is because the length M_{L} of the media 34 is significantly larger than the height M_{H} (the ratio M_{L}:M_{H} is approximately 8:1)—and so as the media 34 is being drawn though by its leading fed edge, the drawing force is far better transmitted along its length to slide the media 34 along without buckling.

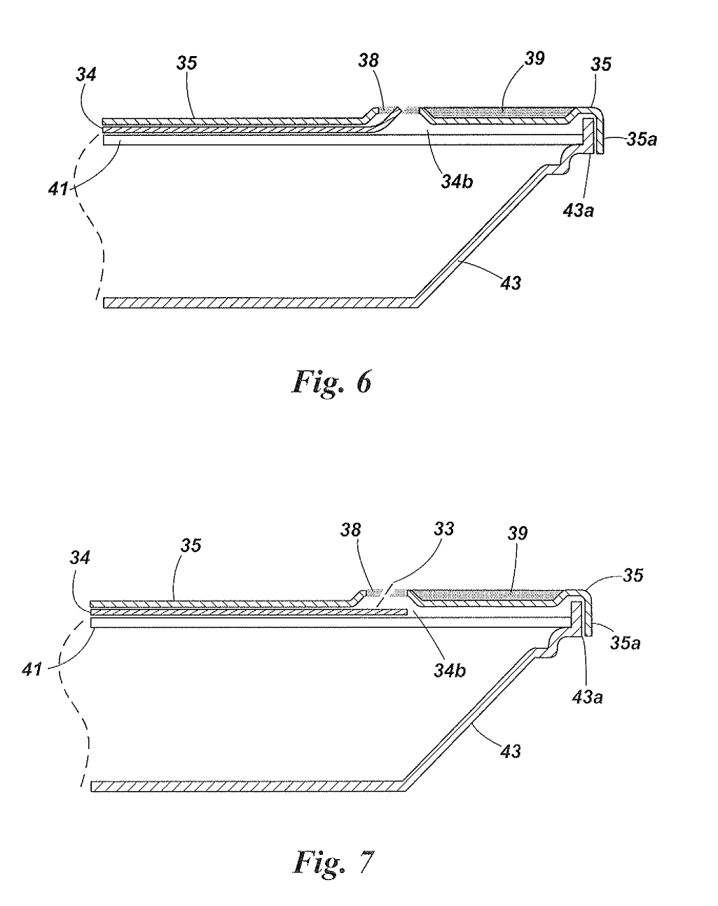

Referring to FIG. 6, the media 34 can be seen to have been slid along the media receiving path 33 to a position such that only the free trailing edge of the media 34 has not passed through the slot 37. Referring the FIG. 7, further sliding of the media 34 will cause the free trailing edge of the media 34, having passed through the slot, to droop down out of alignment with the media receiving path 33 and into a media capture portion 34b. The media 34 thus is received into the media support means 32 in the inserted position in which it can be displayed. When in the inserted position, the media 34 lies flat in substantially parallel orientation with the lens portion 41 and the frame 35. Thus, when in the inserted position, sliding the media 34 along itself will not cause the media 34 to be removed from the media support means 32 as the free trailing edge will be captured in the media capture portion 34b.

In order to remove the media from the inserted position as shown in FIG. 7, a user would need to insert a finger into the recess 38 to pinch the free trailing edge of the media 34 so as to lift and guide it out through the slot 37.

As can be seen in FIG. 2, the recess 38 is sized to be less elongate than the slot 37 so as to allow a finger to be inserted easily to grasp the free end (at the trailing edge) of the media 34, but at the same time preventing removal of the free end of the media 34, except when guided through the slot 37.

The media 34 is made from a flexible elongate material, and is translucent. Thus the backlighting of the media permits coloured advertising images on the media 34 to be brightly lit. Since the media 34 backs onto the lens portion 41, the entire area of the media 34 that is visible through the opening 36 is lit. Since the media 34 is exposed through the opening 36, it is weatherproofed to maintain its integrity, and has a wipe-clean surface. This surface can, for example, comprise a thin translucent plastics laminate coating.

Thus, the barrier system 1 as described above allows advertising media 34 to be conveniently inserted and removed manually from a barrier 30 by simply moving the media 34 along the media receiving path 33. No special tools are needed and there is no requirement to change the configuration of moving parts (e.g. screws, hinges, flap)—which can become lost or suffer mechanical failure. Furthermore, the lighting arrangement 50 and the translucent nature of the media 34 maximises the aesthetic appeal and visibility of the media 34 being displayed. The activation of the lighting arrangement 50 in response to a control signal also maximises the visual impact of the media.

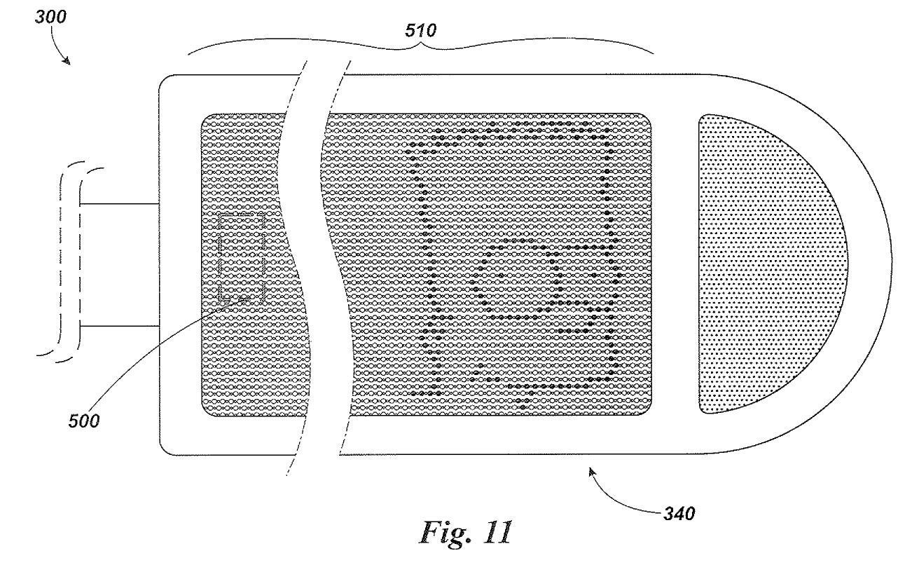

A second embodiment of the present invention is shown in FIG. 11. In this embodiment, the barrier 300 comprises a matrix of LEDs 510. Individual LEDs are selectively controlled by a display controller 500 (shown in broken outline within the barrier behind the matrix of LEDs 510). The display controller 500 comprises a receiver, a memory and a processor. The receiver is arranged to receive data across a communication channel (for example, a wired or wireless data link) from a user controlled data source—for example a remote computer, or a memory card. The received data is stored in the memory.

The received data contains information about images to be displayed, and instructions on how the images are to be displayed (e.g. duration). The processor accesses the memory and controls the matrix of LEDs in dependence on the data. Thus, LEDs can be selectively illuminated to form an image 340 suitable for advertising. The LEDs can also be driven at different time intervals to create moving images.

Techniques for driving a matrix of LEDs, or other such displays are well known to persons skilled in the art of electronic display systems, and so will not be further described for the sake of brevity.

It will be understood that features of the first embodiment of the present invention (for example, the access control means 20, and the drive unit 10) are equally applicable in respect of the second embodiment where the context allows.

1. A barrier for use in a barrier system in which the barrier is movable to control access past the barrier, said barrier comprising a media support means arranged to support a removable media to be displayed, said support means defining a media receiving path along which the media is movable to an inserted position in which the media is displayed.

2. A barrier according to claim 1, wherein the media support means comprises a frame which defines an opening through which an inserted media is substantially visible, said opening being arranged to facilitate manual manipulation of media during media insertion and/or removal.

3. A barrier according to claim 1, wherein the media receiving path is non-linear, at least in part.

4. A barrier according to claim 1, wherein the media support means comprises a slot allowing media to be inserted and/or removed into the media receiving path from an exterior of the support means.

5. A barrier according to claim 4, wherein the slot is shaped to incorporate a recess for facilitating manual manipulation of an inserted media to be removed, said recess being of a different proportion to that of the cross section of a media to be inserted, and being sized to permit a finger of a user to grasp an inserted media for facilitating removal of said inserted media.

6. A barrier according to claim 1, wherein the media support means comprises a media receiving cavity which is, at least in part, occupied by an inserted media after the inserted media has been moved into the inserted position by movement along the media receiving path, said media receiving cavity comprising a media capture portion for capturing a trailing edge of an inserted media.

7. A barrier according to claim 1, wherein the barrier comprises a lighting arrangement arranged to illuminate a media to be displayed.

8. A barrier according to claim 7, wherein the lighting arrangement is a backlit lighting arrangement.

9. A barrier according to claim 7, wherein the lighting arrangement uniformly illuminates substantially the entire visible surface of an inserted media.

10. A barrier according to claim 7, wherein the lighting arrangement comprises diffusing means arranged to provide uniform illumination.

11. A barrier according to claim 7, wherein the lighting arrangement comprises a plurality of solid-state light sources.

12. A barrier according to claim 11, wherein the plurality of solid-state light sources are spaced from the media receiving path at a distance chosen to allow light to diffuse to an extent that a media in the inserted position is illuminated substantially uniformly.

13. A barrier according to claim 7, wherein the lighting arrangement comprises
a reflector arranged to direct light to illuminate an inserted media to be displayed.

14. A barrier according to claim 7, wherein the barrier is arranged to receive a control signal from a sensor for detecting the presence or absence of a predetermined object within the vicinity of the barrier and control the lighting arrangement in response to the control signal.

15. A barrier for use in a barrier system in which the barrier is movable to control access past the barrier, said barrier comprising media support means arranged to support a media to be displayed, said barrier further comprising a lighting arrangement arranged to illuminate said media.

16. A barrier for use in a barrier system in which the barrier is movable to control access past the barrier, said barrier comprising media support means arranged to support a media to be displayed, said barrier further comprising a lighting arrangement arranged to illuminate said media wherein the lighting arrangement is a lighting arrangement according to claim 14.

17. A barrier kit comprising a barrier according to claim 1 further comprising a media suitable for advertising for support by the media support means of the barrier.

18. A barrier kit according to claim 17, wherein the media is translucent or transparent, at least in part.

19. A barrier kit according to claim 17, wherein the media is made from a flexible, elongate, weatherproof material.

20. A barrier kit according to claim 17, comprising a plurality of interchangeable media suitable for advertising.

21. A barrier for use in a barrier system in which the barrier is movable to control access past the barrier, said barrier comprising a lighting arrangement arranged to display an illuminated image suitable for advertising.

22. A barrier according to claim 21, wherein the lighting arrangement comprises an electronic display means.

23. A barrier according to claim 22, wherein the lighting arrangement comprises a plurality of light emitting diodes in a matrix arrangement.

24. A barrier system comprising a barrier according to claim 1, the barrier system being operable to move the barrier to control access past the barrier.

25. A barrier system according to claim 24, comprising an electrical power source located outside of the barrier, said barrier system further comprising a wiring configuration arranged to electrically couple the barrier to the power source, said wiring configuration being arranged to maintain the electric coupling during movement of the barrier.

26. (canceled)

27. A barrier system comprising a barrier kit according to claim 17, the barrier system being operable to move the barrier to control access past the barrier.
